(19) United States
(12) Patent Application Publication
(10) Pub. No.: US 2018/0173393 A1
(43) Pub. Date: Jun. 21, 2018

(54) APPARATUS AND METHOD FOR VIDEO ZOOMING BY SELECTING AND TRACKING AN IMAGE AREA

(71) Applicant: THOMSON Licensing, Issy-Ies-Moulineaux (FR)

(72) Inventors: Alain VERDIER, VERN SUR SEICHE (FR); Christophe CAZETTES, Noyal-Châtillon-sur-Seiche (FR); Cyrille GANDON, Rennes (FR); Bruno GARNIER, SAINT JEAN SUR COUESNON (FR)

(21) Appl. No.: 15/737,273

(22) PCT Filed: Jun. 14, 2016
(86) PCT No.: PCT/EP2016/063559

§ 371 Date: Dec. 15, 2017

(30) Foreign Application Priority Data
Jun. 15, 2015 (EP) 15305928.2

(51) Int. Cl. G06F 3/0488; G06K 9/00; G06K 9/22; G06K 9/32

(52) U.S. Cl. CPC G06F 3/0488; G06K 9/00221; G06K 9/00362; G06K 2009/3291; G06K 9/3233; G06F 2203/04806; G06K 9/22

(57) ABSTRACT

The principles disclose a method enabling a video zooming feature while playing back or capturing a video signal on a device (100). A typical example of device implementing the method is a handheld device such as a tablet or a smartphone. When the zooming feature is activated, the user double taps to indicate the area on which he wants to zoom in. This action launches the following actions: first, a search window (420) is defined around the position of the user tap, then human faces are detected in this search window, the face (430) nearest to the tap position is selected, a body window (440) and a viewing window (450) are determined according to the selected face and some parameters. The viewing window (450) is scaled so that it is only showing a partial area of the video. The body window (440) tracking (BW) will be tracked in the video stream and motions of this area within the video will be applied to the viewing window (450), so that it stays focused on the previously selected person of interest. Furthermore, it is continuously checked that the selected face is still present in the viewing window (450). In case of error regarding the last check, the viewing window position is adjusted to include the position of the detected face. The scaling factor of the viewing window is under control of the user through a slider preferably displayed on the screen.

### TECHNICAL FIELD

The present disclosure relates generally to devices able to display videos during their playback or their capture, and in particular to a video zooming feature including a method for selection and tracking of a partial area of an image implemented on such a device. Handheld devices equipped with a touch screen, such as a tablet or smartphone are representative examples of such devices.

### BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Selection of a partial area of an image displayed on a screen is ubiquitous in today's computer systems, for example in image editing tools such as Adobe Photoshop, Gimp, or Microsoft Paint. The prior art comprises a number of different solutions that allow the selection of a partial area of an image.

One very common solution is a rectangular selection based on clicking on a first point that will be the first corner of the rectangle and while keeping the finder pressed on the mouse moving the pointer to a second point that will be the second corner of the rectangle. During the pointer move the selection rectangle is drawn on the screen to allow the user to visualize the selected area of the image. Please note that in alternative to the rectangular shape, the selection can use any geometrical shape such as a square, a circle, an oval or more complex forms. A major drawback of this method is the lack of precision for the first corner. The best example illustrating this issue is the selection of a circular object such as a ball with the rectangle. No reference can help the user in knowing where to start from. To solve this issue, some implementations propose so-called handles on the rectangle, allowing to resize it and to adjust it with more precision by clicking on these handles and moving them to a new location. However this requires multiple interactions from the user to adjust the selection area.

Other techniques provide non-geometrical forms of selection, closer to the image content and sometimes using contour detection algorithm to follow objects pictured in the image. In such solutions, generally the user tries to follow the contour of the area he wants to select. This forms a trace that delimits the selection area. However, the drawback of this solution is that the user must close the trace by coming back to the first point to indicate that his selection is done, which is sometimes difficult.

Some of these techniques have been adapted to the particularity of touch screen equipped devices such as smartphones and tablets. Indeed, in such devices, the user interacts directly with his finger on the image displayed on the screen. CN101458586 proposes to combine multiple finger touches to adjust the selection area with the drawback of relatively complex usability and additional learning phase for the user. US20130234964 solves the problem of masking the image with the finger by introducing a shift between the area to be selected and the point where the user presses the screen. This technique has the same drawbacks as the previous solution: the usability is poor and adds some learning complexity.

Some smartphones and tablets propose a video zooming feature, allowing the user to focus on a selected partial area of the image, either while playing back videos or while recording videos using the integrated camera. This video zooming feature requires the selection of a partial area of the image. Using traditional approach of pan and zoom for this selection or any one of the solutions introduced above is not efficient, in particular when the user wants to focus on a human actor. Indeed the position of the actor on the screen changes during time making it difficult to adjust manually the zooming area continuously by zooming out and zooming in again on the right area of the image.

It can therefore be appreciated that there is a need for a solution that allows a live zooming feature that focuses on an actor and that addresses at least some of the problems of the prior art. The present disclosure provides such a solution.

### SUMMARY

In a first aspect, the disclosure is directed to a data processing apparatus for zooming into a partial area of a video, comprising a screen configured to display the video comprising a succession of images and obtain coordinates of a touch made on the screen displaying the video; and a processor configured to select a human face with smallest geometric distance to the coordinates of the touch, the human face having a size and a position, determine size and position of a partial viewing area relative to the size and the position of the selected human face and display the partial viewing area according a scale factor. A first embodiment comprises determining size and position of the partial viewing area by detecting a set of pixels of a distinctive element associated with the selected face, the distinctive element having a size and a position that are determined by geometric functions on the size and the position of the selected human face. A second embodiment comprises adjusting the position of the partial viewing area of the image according to a motion of the set of pixels related to the distinctive element detected between the image and a previous image in the video. A third embodiment comprises adjusting the size of the partial viewing area of the image according to the value of a slider determining the scale factor. A fourth embodiment comprises adjusting the size of the partial viewing area of the image according a touch on a border of the screen to determine the scale factor, different areas of the screen border corresponding to different scale factors. A fifth embodiment comprises checking that the selected face is included in the partial viewing area and, when this is not the case, adjusting the position of the partial viewing area to include the selected face. A sixth embodiment comprises performing the detection of human faces only on a part of the image, whose size is a ratio of the screen size and whose position is centered on the coordinates of the touch. A seventh embodiment comprises detecting a double tap to provide the coordinates of the touch on the screen.

In a second aspect, the disclosure is directed to a method for zooming into a partial viewing area of a video, the video comprising a succession of images, the method comprising obtaining the coordinates of a touch made on a screen displaying the video, selecting a human face with smallest geometric distance to the coordinates of the touch, the human face having a size and a position, determining size and position of a partial viewing area relative to the size and the position of the selected human face and displaying the partial viewing area according a determined scale factor. A first embodiment comprises determining the size and position of the partial viewing area by detecting a set of pixels of a distinctive element associated with the selected face, the distinctive element having a size and a position that are determined by geometric functions on the size and the position of the selected human face. A second embodiment comprises adjusting the position of the partial viewing area of the image according the motion of the set of pixels related to the distinctive element detected between the image and a previous image in the video. A third embodiment comprises, when the set of pixels of a distinctive element associated with the selected face is not included in the partial viewing area, adjusting the position of the partial viewing area to include this set of pixels.

In a third aspect, the disclosure is directed to a computer program comprising program code instructions executable by a processor for implementing any embodiment of the method of the first aspect.

In a third aspect, the disclosure is directed to a computer program product which is stored on a non-transitory computer readable medium and comprises program code instructions executable by a processor for implementing any embodiment of the method of the first aspect.

### BRIEF DESCRIPTION OF DRAWINGS

Preferred features of the present disclosure will now be described, by way of non-limiting example, with reference to the accompanying drawings, in which:

FIG. 1 illustrates an exemplary system in which the disclosure may be implemented;

FIGS. 2A, 2B, 2C, 2D depict the results of the operations performed according to a preferred embodiment of the disclosure;

FIG. 3 illustrates an example of flow diagram of a method according to the preferred embodiment of the disclosure;

FIG. 4A and 4B illustrate the different elements defined in the flow diagram of FIG. 3; and

FIG. 5A and 5B illustrate an example of implementation of the zoom factor control through a slider displayed on the screen of the device.

### DESCRIPTION OF EMBODIMENTS

The principles disclose a method enabling a video zooming feature while playing back or capturing a video signal on a device. A typical example of device implementing the method is a handheld device such as a tablet or a smartphone. When the zooming feature is activated, the user double taps to indicate the area on which he wants to zoom in. This action launches the following actions: first, a search window is defined around the position of the user tap, then human faces are detected in this search window, the face nearest to the tap position is selected, a body window and a viewing window are determined according to the selected face and some parameters. The viewing window is scaled so that it is only showing a partial area of the video. The body window will be tracked in the video stream and motions of this area within the video will be applied to the viewing window, so that it stays focused on the previously selected person of interest. Furthermore, it is continuously checked that the selected face is still present in the viewing window. In case of error regarding the last check, viewing window position is adjusted to include the position of the detected face. The scaling factor of the viewing window is under control of the user through a slider preferably displayed on the screen.

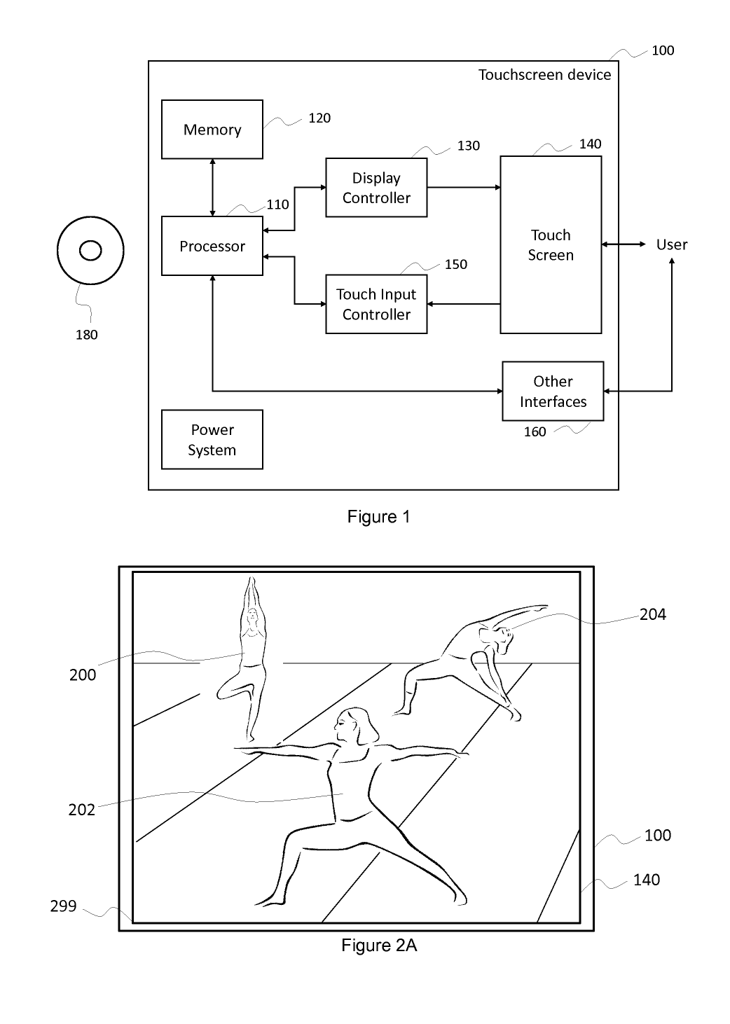

FIG. 1 illustrates an exemplary apparatus in which the disclosure may be implemented. A tablet is one example of device, a smartphone is another example. The device 100 preferably comprises at least one hardware processor 110 configured to execute the method of at least one embodiment of the present disclosure, memory 120, a display controller 130 to generate images to be displayed on the touch screen 140 for the user, and a touch input controller 150 that reads the interactions of the user with the touch screen 140. The device 100 also preferably comprises other interfaces 160 for interacting with the user and with other devices and a power system 170. The computer readable storage medium 180 stores computer readable program code that is executable by the processor 110. The skilled person will appreciate that the illustrated device is very simplified for reasons of clarity.

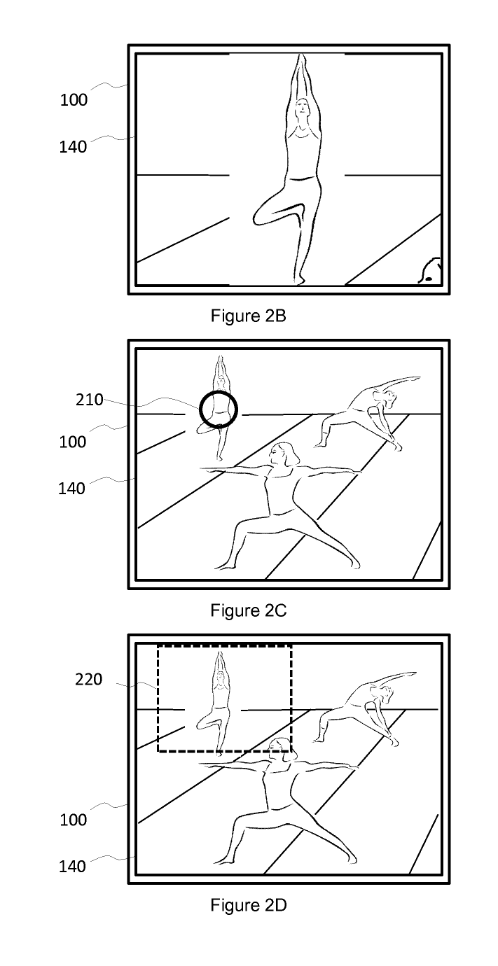

In this description, all coordinates are given in the context of the first quadrant, meaning that the origin of images (point with coordinates 0,0) is taken at the bottom left corner, as depicted by element 299 in FIG. 2A.

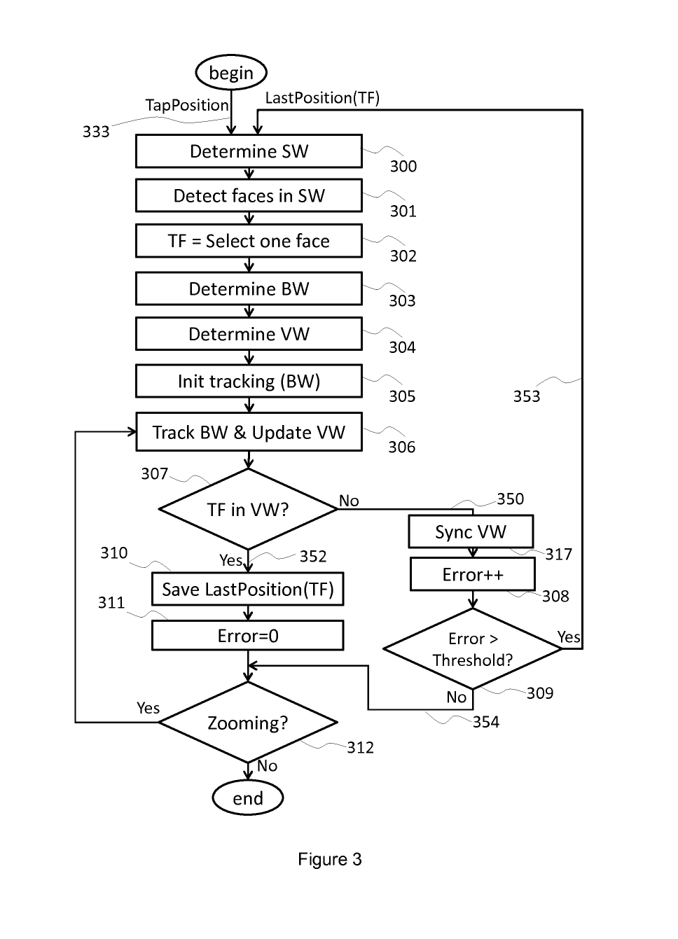

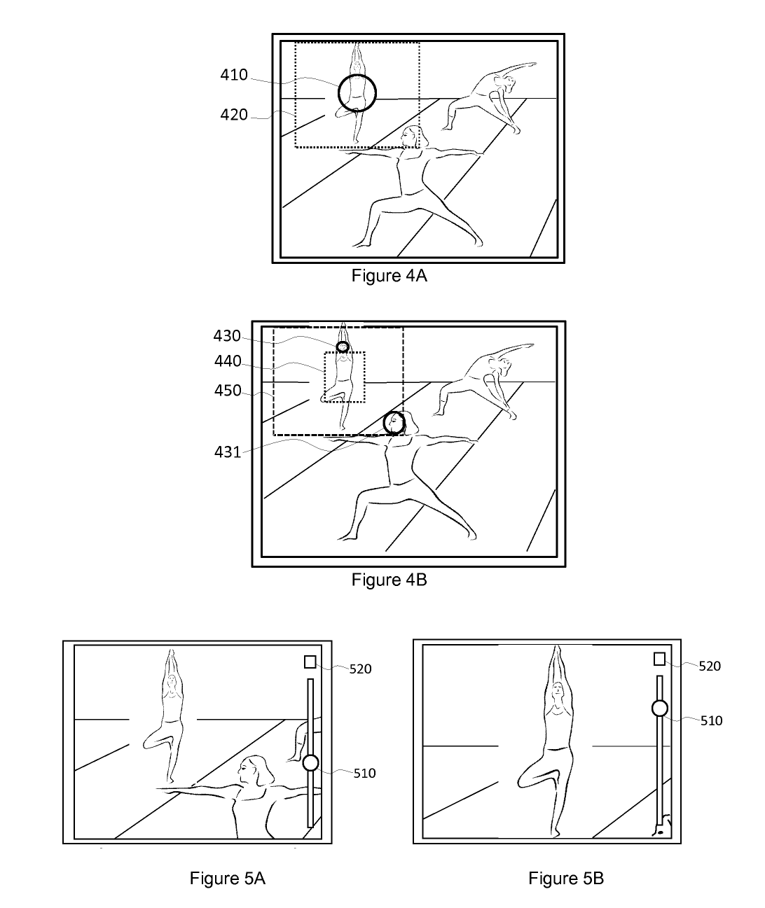

FIGS. 2A, 2B, 2C, 2D depicts the results of the operations performed according to a preferred embodiment of the disclosure. FIG. 2A shows the device 100 comprising the screen 140 displaying a video signal representing a scene of 3 dancers, respectively 200, 202 and 204. The video is either played back or captured. The user is interested in dancer 200. His objective is that the dancer 200 and surrounding details occupy the majority of the screen, as illustrated in FIG. 2B, so that more details becomes visible of the action of this dancer, without being bothered by the movements of other dancers. To this end, the user activates a zooming feature and double taps on the body of his preferred dancer 200, as illustrated by the circle 210 in FIG. 2C. This results in the definition of a viewing window 220, in FIG. 2D surrounding the dancer 200. The device zooms on this viewing window, as shown in FIG. 4D and tracks continuously the body of the dancer to follow its movements until the zooming feature is stopped as will be explained in more detail. During the tracking, the device also continuously verifies that the head of the dancer is shown in the viewing window 220. When the face has been detected in the search window but when its position is outside of the viewing window, this is considered as an error. In this case a resynchronization mechanism updates the position of the viewing window and the tracking algorithm, allowing to catch the head again and to update the viewing window accordingly. When this error appears too frequently, i.e. more than a determined threshold, the face detection is extended over the entire image. FIG. 3 illustrates an example of flow diagram of a method according to the preferred embodiment of the disclosure. The process starts while a video is either played back or captured by the device 100 and when the user activates the zooming feature. The user double taps the screen 140 at a desired location, for example on the dancer 200 as represented by element 410 in FIG. 4A. The position of the double tap is obtained by the touch input controller 150, for example calculated as the barycentre of the area captured as finger touch and corresponds to a position on the screen defined by the couple of coordinates TAP.X and TAP.Y. These coordinates are used, in step 300, to determine a search window (SW) represented by element 420 in FIG. 4A. The search window is preferably a rectangular area on which a face detection algorithm will operate in order to detect human faces, using well known image processing techniques. Restricting the search to only a part of the overall image allows to improve the response time of the face detection algorithm. The position of the search window is centered around the tap position. The size of the search window is defined as a proportion a of the screen size. A typical example is α=25% in each dimension, leading to a search area of only 1116^{th} of the complete image, approximately speeding up the detection phase 16 times. The search window is defined by two corners of the rectangle, for example as follows, with respectively the coordinates SW.X_{Min}, SW.Y_{Min} and SW.X_{Max}, SW.Y_{Max}, and SCR.W and SCR.H being respectively the screen width and height:

SW.X_{Min}=TAP.X−(α/2×SCR.W); SW.Y_{Min}=TAP.Y−(α/2×SCR.H);

SW.X_{Max}=TAP.X+(α/2×SCR.W); SW.Y_{Max}=TAP.Y+(α/2×SCR.H);

The face detection is launched on the image included in the search window, in step 301. This algorithm returns a set of detected faces, represented by elements 430 and 431 in FIG. 4B, with for each an image representing the face, the size of the image and the position of the image in the search window. In step 302, the face that is closest to the position of the user tap is chosen, represented by element 430 in FIG. 4B. For example, the distance between the tap position and each center of the image of the detected faces is computed as follows:

D[i]=SQRT((SW.X_{Min}+DF[i].X+DF[i].W/2−TAP.X)²+(SW.Y_{Min}+DF[i].Y+DF[i].H/2−TAP.Y)²)

In the formula, DF[ ] is the table of detected faces with for each face its horizontal position DF[i].X, vertical position DF[i].X, width DF[i].X, height DF[i].X, and D[ ] is the resulting table of distances. The face with minimal distance value in the table D[ ] is selected, thus becoming the track face (TF). The position of the track face (TF.X and TF.Y) and its size (TF.W and TF.H) are then used, in step 303, to determine the body window (BW), represented by element 440 in FIG. 4B. The body window will be used for tracking purposes, for example using a feature based tracking algorithm. In the general case, from an image analysis point of view, as far as feature based tracker is concerned, the body element is more discriminatory than the head regarding both the background of the image and other humans potentially present in a scene. The definition of the body window from the track face is done arbitrarily. It is a window located below the track face and whose dimensions are proportional to the track face dimensions, with parameters α_{w} horizontally and αₕ vertically. For example, the body window is defined as follows:

BW.W=α_{w}×TF.W; BW.H=αₕ×TF.H;

BW.X=TF.X+TF.W/2−BW.W/2; BW.Y=TF.Y−BW.H;

Statistics from a representative set of images allowed to define a heuristic that proved to be successful for the tracking phase with values of α_{w}+3 and αₕ=4. Any other geometric function can be used to determine the body window from the track face.

Similarly, the viewing window (VW), represented by element 450 in FIG. 4B, is determined arbitrarily, in step 304. Its position is defined by the position of the track face and its size is a function of the track face size, a zoom factor α′ and the screen dimensions (SD). Preferably, the aspect ratio of the viewing window respects the aspect ratio of the screen. An example of definition of the viewing window is given by:

VW.H=α′×TF.H; VW.W=TF.H×SD.W/SD.H;

VW.X=min (0, TF.X+TF.W/2−VW.W/2);

VW.Y=min (0, TF.Y+TF.H/2−VW.H/2);

Experimental values of α′=10 provided satisfying results as default value. However, this parameter is under control of the user and its value may be changed during the process. In step 305, the body window is provided to the tracking algorithm. In step 306, the tracking algorithm, using well known image processing techniques, tracks the position of the pixels composing the body window image within the video stream. This is done by analysing successive images of the video stream and providing an estimation of the motion (MX, MY) that was detected between the successive positions of the body window in a first image of the video stream and the further image. The motion detected impacts the content of the viewing window. When the position of the dancer 200 in the original image moved to the right so that the dancer 200 is now in the middle of the image, new elements may appear at the left of the dancer 200, for example another dancer. Therefore, the content of the viewing window is updated according to this new content, the selected zoom factor α′ and according to the motion detected. This update includes extracting a partial area of the complete image located at the updated position that is continuously saved in step 306, scaling it according to the zoom factor α′ and displaying it. With image[ ] being the table of successive images composing the video, VW[i−1].X and VW[i−1].Y the saved coordinates of viewing window in previous image:

VW.image =extract (image[i], VW[i−1].X+MX, VW[i−1].Y+MY, VW.W/α′, VW.H/α′);

VW.image=scale (VW.image, α′);

The previous image extraction enables the viewing window to follow the motion detected in the video stream. Frequent issues with tracking algorithms are related to occlusions of the tracked areas and drifting of the algorithm. To prevent such problems, an additional verification is performed in step 307. It consists in verifying that the track face is still visible in the viewing window. If it is not the case, in branch 350, that means that either the tracking has drifted and is no more tracking the right element, or that a new element is masking the tracked element, for example by occlusion since the new element is in the foreground. This has for effect, in step 317 to resynchronize the position of the viewing window with the last detected position of the track face. Then, in step 308, an error counter is incremented. It is then checked, in step 309, if the error count is higher than a determined threshold. When this is the case, in branch 353, the complete process is restarted with the exception that the search window is extended to the complete image and the starting position is no more the tap position provided by the user but the last detected position of the track face, as verified in step 307 and previously saved in step 310. As long as the error count is lower than the threshold, in branch 354, the process continues normally. Indeed, in the case of temporary occlusion, the track face may reappear after a few images and therefore the tracking algorithm will be able to recover easily without any additional measure. When the check of step 307 is true, in branch 352, that means that the track face has been recognized within the viewing window. In this case, the position of the track face is saved, in step 310, and the error count is reset, in step 311. It is then checked, in step 312, whether or not the zooming function is still activated. If it is the case, the process loops back to tracking and update of step 306. If it is not the case, the process is stopped and the display will be able to show again the normal image instead of the zoomed one.

Preferably, the track face recognition and body window tracking iteratively enhance the model of the face and the body, upon the tracking and the detection operations performed in step 306, allowing to improve further recognitions of both elements.

FIG. 4A and 4B illustrate the different elements defined in the flow diagram of FIG. 3. In FIG. 4A, the circle 410 corresponds to the tap position and the rectangle 420 corresponds to the search window. In FIG. 4B, circles 430 and 431 correspond to the faces detected in step 301. The circle 430 represents the track face selected in step 302. The rectangle 440 represents the body window defined in step 303 and the rectangle 450 corresponds to the viewing window, determined in step 304.

FIG. 5A and 5B illustrate an example of implementation of the zoom factor control through a slider displayed on the screen of the device. Preferably, the zoom factor α′ used in steps 304 and 306 to build and update the viewing window is configurable by the user during the zooming operation, for example through a vertical slider 510 located on the right side of the image and used to set the value of the zoom factor. In FIG. 5A, the slider 510 is set to a low value, towards the bottom of the screen, therefore inducing a small zoom effect. In FIG. 5B, the slider 510 is set to a high value, towards the top of the screen, therefore inducing an important zoom effect. Furthermore, the graphical element 520 can be activated by the user to stop the zooming feature. This slider can also be not displayed on the screen, to avoid reducing the area dedicated to the video. For example, the right border of the screen can control the zoom factor when touched at the bottom for limited zoom and at the top for maximal zoom, but without any graphical element symbolizing the slider. This results is a screen that looks like the illustration of FIG. 2D. Alternatively, the slider can also be displayed briefly and disappear as soon as the change of zoom factor is performed.

In the preferred embodiment, the video zooming feature is activated on user request. Different means can be used to establish this request, such as validating an icon displayed on the screen, by pressing a physical button on the device or through a vocal command.

In a variant, the focus of interest is not a human person but an animal, an object, such as a car, a building or any kind of object. In this case, the recognition and tracking algorithms as well as the heuristic used in steps 301 and 306 are adapted to the particular characteristics of the element to be recognized and tracked but the other elements of the methods are still valid. In the case of a tree for example, the face detection is replaced by a detection of a tree trunk, different heuristics will be used to determine the area to be tracked, defining a tracking area over the trunk. In this variant, the user preferably chooses the type of video zooming before activating the function, therefore allowing to use the most appropriate algorithms.

In another variant, prior to detection of the particular element in step 301, a first analysis is done on the search window to determine the type of elements present in this area, between a set of determined types such as humans, animals, cars, buildings and so on. The type of elements are listed in decreasing order of importance. One criteria for importance is the size of the object within the search window. Another criteria is the number of elements for each type of object. The device selects the recognition and tracking algorithms according to the type of element at the top of list. This variant provides an automatic adaptation of the zooming feature to multiple type of elements.

In one variant, the partial viewing window 450 is displayed in full screen, which is particularly interesting when displaying a video with a resolution higher than the screen resolution. In an alternative variant, the partial viewing window occupies only a part of the screen, for example a corner in a picture-in-picture manner, allowing to have both the global view of the complete scene and details of a selected person or element.

In the preferred embodiment, the body window is determined according the face track parameters. More precisely, a particular heuristic is given for the case of human detection. Any other geometric function can be used for that purpose, preferably based on the size of the first element detected, i.e. the track face in the case of human detection. For example a vertical scaling value, an horizontal scaling value, an horizontal offset and a vertical offset can be used to determine the geometric function. These values preferably depend on the parameters of the first element detected.

The images used in the figures are in the public domain, obtained through pixabay.com.

As will be appreciated by one skilled in the art, aspects of the present principles can take the form of an entirely hardware embodiment, an entirely software embodiment (including firmware, resident software, micro-code and so forth), or an embodiment combining hardware and software aspects that can all generally be defined to herein as a “circuit”, “module” or “system”. Furthermore, aspects of the present principles can take the form of a computer readable storage medium. Any combination of one or more computer readable storage medium(s) can be utilized. Thus, for example, it will be appreciated by those skilled in the art that the diagrams presented herein represent conceptual views of illustrative system components and/or circuitry embodying the principles of the present disclosure. Similarly, it will be appreciated that any flow charts, flow diagrams, state transition diagrams, pseudo code, and the like represent various processes which may be substantially represented in computer readable storage media and so executed by a computer or processor, whether or not such computer or processor is explicitly shown. A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information there from. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

Each feature disclosed in the description and (where appropriate) the claims and drawings may be provided independently or in any appropriate combination. Features described as being implemented in hardware may also be implemented in software, and vice versa. Reference numerals appearing in the claims are by way of illustration only and shall have no limiting effect on the scope of the claims.

1. A data processing apparatus for zooming into a partial viewing area of a video comprising a succession of images, the apparatus comprising:
a screen configured to display the video;
a processor configured to:
select a human face close to the coordinates of a selection made on the screen, the human face having a size and a position; and
display a partial viewing area according a scale factor, wherein size and position of the partial viewing area are relative to the size and the position of the selected human face.

2. The apparatus of claim 1 wherein the processor is configured to determine size and position of the partial viewing area by detecting a set of pixels of a distinctive element associated with the selected face, the distinctive element having a size and a position that are determined by a combination of translation and scaling functions on the size and the position of the selected human face to comprise the human body related to the selected human face.

3. The apparatus of claim 1 wherein the processor is configured to adjust the position of the partial viewing area of the image according to a motion of the set of pixels related to the distinctive element detected between the image and a previous image in the video.

4. The apparatus of claim 1 wherein the processor is configured to adjust the size of the partial viewing area of the image according to the value of a slider determining the scale factor.

5. The apparatus of claim 1 wherein the processor is configured to adjust the size of the partial viewing area of the image according a touch on a border of the screen to determine the scale factor, different areas of the screen border corresponding to different scale factors.

6. The apparatus of claim 1 wherein the processor is configured to check that the selected face is included in the partial viewing area and, when this is not the case, adjusting the position of the partial viewing area to include the selected face.

7. The apparatus of claim 1 wherein the processor is configured to perform the detection of human faces only on a part of the image, whose size is a ratio of the screen size and whose position is centered on the coordinates of the touch selection made on the screen.

8. The apparatus of claim 1 wherein the processor is configured to detect a double tap to provide the coordinates of the touch selection made on the screen.

9. A method for zooming into a partial viewing area of a video, the video comprising a succession of images, the method comprising:
selecting a human face close to a selection made on a screen displaying the video, the human face having a size and a position;
displaying a partial viewing area according a scale factor, wherein size and position of the partial viewing area are relative to the size and the position of the selected human face.

10. A method according to claim 9 where size and position of the partial viewing area are determined by detecting a set of pixels of a distinctive element associated with the selected face, the distinctive element having a size and a position that are determined by a combination of translation and scaling functions on the size and the position of the selected human face to comprise the human body related to the selected human face.

11. A method according to claim 9 where the motion of the set of pixels related to the distinctive element detected between the image and a previous image in the video is used to adjust the position of the partial viewing area of the image.

12. A method according to claim 9 where, when the set of pixels of a distinctive element associated with the selected face is not included in the partial viewing area, the position of the partial viewing area is adjusted to include this set of pixels.

13. A method according to claim 9 where the selection made on the screen is a double tap.

14. Computer program comprising program code instructions executable by a processor for implementing the steps of a method according to claim 9.

15. Computer program product which is stored on a non-transitory computer readable medium and comprises program code instructions executable by a processor for implementing the steps of a method according to claim 9.
